(19) United States
(12) Patent Application Publication
(10) Pub. No.: US 2006/0104787 A1
(43) Pub. Date: May 18, 2006

(54) Substrate delivering apparatus

(76) Inventors: Kyung-won Kang, Suwon-si (KR); Yong-won Choi, Yongin-si (KR); Jae-chul Hwang, Seoul (KR); Yong-jun Park, Seoul (KR); Doo-hwan Choi, Anyang-si (KR); Young-chul Song, Suwon-si (KR); Jun-young Lee, Yongin-si (KR); Valeri Kraev, Suwon-si (KR)

Correspondence Address: STANZIONE & KIM, LLP, 919 18TH STREET, N.W., SUITE 440, WASHINGTON, DC, 20006, US

(21) Appl. No.: 11/153,557

(22) Filed: Jun. 16, 2005

(30) Foreign Application Priority Data
Jun. 18, 2004 (KR) 2004-45749

(51) Int. Cl. B66C 23/00

(52) U.S. Cl. 414/728

(57) ABSTRACT

A substrate delivering apparatus that delivers a substrate includes a base part, a moving part mounted on the base part so as to perform linear movement and having a rotating body, a pair of frame parts mounted in parallel on opposite sides of the moving part and having heights that are adjustable, and a delivering part that is connected between the pair of frame parts and is vertically displaced according to an adjustment of the heights of the frame parts. Thus, the substrate delivering apparatus is capable of facilitating delivery of a substrate while maintaining structural stability.

### CROSS-REFERENCE TO RELATED APPLICATIONS

This application claims the benefit of Korean Patent Application No. 2004-45749, filed on Jun. 18, 2004, in the Korean Intellectual Property Office, the disclosure of which is incorporated herein in its entirety by reference.

### BACKGROUND OF THE INVENTION

1. Field of the Invention

The present general inventive concept relates to a substrate delivering apparatus, and more particularly to, a substrate delivering apparatus having an improved delivering mechanism.

2. Description of the Related Art

Typically, semiconductor fabricating equipment includes a substrate delivering apparatus to automatically deliver semiconductor components, such as an LCD substrate, in order to increase efficiency of work done by an unmanned automated work line.

Recently, there has been an increase in demand for large-sized display apparatuses. Due to this increase in demand, sizes of substrates used to manufacture display apparatuses have gradually increased. This increase in the sizes of substrates used to manufacture display apparatuses has created a need for apparatuses capable of handling large substrates during manufacturing processes. For example, in some manufacturing processes, a substrate delivering apparatus may have to deliver a substrate in a vertical direction by a distance of about 4 meters.

Most conventional substrate delivering apparatuses support a delivering part, such as an arm/hand module, that is substantially responsible for delivering the substrate as a single direct moving shaft (vertical shaft). Thus, where a large-sized substrate is to be delivered, the center of gravity of the large-sized substrate does not coincide with a rotation center of the delivering part. Problems with structural stability are likely to result when a load to a rotation shaft is increased during a rotation movement.

In addition, as a height of the direct moving shaft is increased, the direct moving shaft may be deformed due to a load and a moment of the delivering part. This may cause deterioration of accuracy and reliability of the conventional substrate delivering apparatus.

### SUMMARY OF THE INVENTION

Accordingly, the present general inventive concept provides a substrate delivering apparatus capable of facilitating delivery of a substrate while maintaining structural stability.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a substrate delivering apparatus that delivers a substrate, the apparatus comprising a base part, a moving part mounted on the base part so as to perform linear movement and having a rotating body, a pair of frame parts mounted in parallel on opposite sides of the moving part and having heights that are adjustable, and a delivering part that is connected between the pair of frame parts and is vertically displaced according to an adjustment of the heights of the pair of frame parts.

The rotating body may include a rotating part being rotatable, and a support plate part mounted on the rotating body such that the support plate part supports the pair of frame parts.

The frame parts may each comprise a fixed frame mounted on top of the support plate part and a moving frame coupled with the fixed frame so as to be elevatable, and the moving frame may be connected to the delivering part.

Both ends of the delivering part may be integrally connected to the pair of frame parts at the moving frames.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a front plan view illustrating a substrate delivering apparatus according to an embodiment of the present general inventive concept;

FIG. 2 is a side view illustrating the substrate delivering apparatus of FIG. 1;

FIG. 3 is a view illustrating an operational state of the substrate delivering apparatus of FIG. 1;

FIGS. 4A and 4B are views illustrating an operational state of a frame part of a substrate delivering apparatus according to another embodiment of the present general inventive concept; and

FIGS. 5A and 5B are views illustrating an operational state of a frame part of a substrate delivering apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

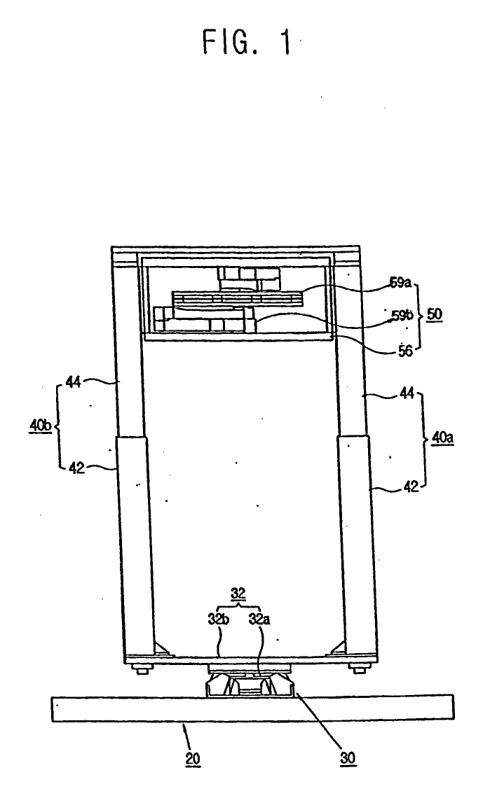

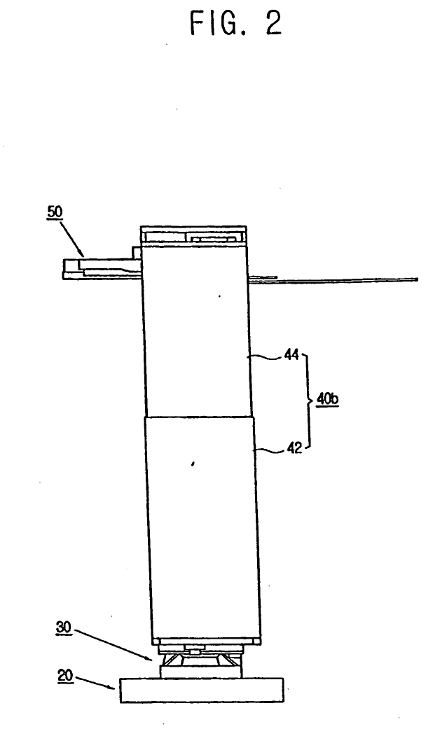

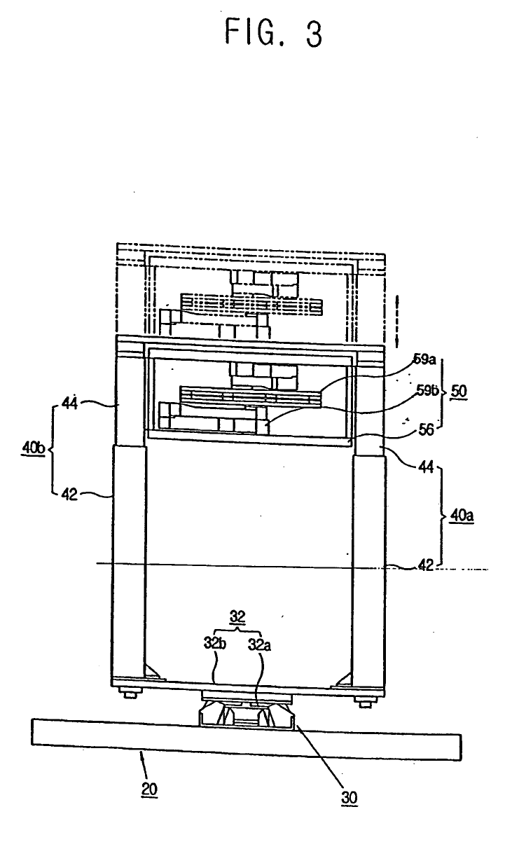

As illustrated in FIGS. 1 to 3, a substrate delivering apparatus according to an embodiment of the present general inventive concept comprises a base part 20, a moving part 30 mounted on the base part 20 so as to perform a linear movement and having a rotating body 32, a pair of frame parts 40a and 40b mounted in parallel on opposite sides of the moving part 30 and having heights that are adjustable, and a delivering part 50 that is vertically displaced according to an adjustment of the heights of the pair of frame parts 40a and 40b.

The base part 20 may include a square-shaped guide (not shown) that guides the moving part 30 so as to perform the linear movement, to thereby play a role as a traveling shaft that. Alternatively, other shapes may be used to form the guide. The movement of the moving part 30 along the guide determines positions of the frame parts 40a and 40b. The moving part 30 can be used as a traveling shaft about which the rotating body 32 rotates.

The moving part 30 performs the linear movement along the guide of the base part 20. The moving part 30 may also be rotated by the rotating body 32. The rotating body 32 comprises a rotating part 32a being rotatable and a support plate part 32b that is mounted on the rotating part 32a such that the rotating part 32a causes the support plate part 32b to rotate with respect to the moving part 30. The support plate part 32b supports the pair of frame parts 40a and 40b. Accordingly, as the support plate part 32b is rotated according to a rotation of the rotating part 32a, the pair of frame parts 40a and 40b provided on the support plate part 32b are also rotated.

The frame parts 40a and 40b each comprise a fixed frame 42 fixedly mounted on a top surface of the support plate part 32b and a moving frame 44 coupled to the fixed frame 42 so as to be elevatable with respect to the fixed frame 42. The moving frame 44 is connected to the delivering part 50 at an end of the moving part 44 that is opposite to another end thereof where the fixed frame 42 is coupled to the moving frame 44.

The delivering part 50 may be vertically displaced by the moving frame 44 since the moving frame 44 may be elevated vertically with respect to the fixed frame 42. The moving frame 44 may be elevated by an elevating part (not shown). The elevating part may be a cylinder using hydraulic or pneumatic pressure. Elevation of the moving frame 44 relative to the fixed frame 42 may depend on an amount of pressure applied to the cylinder.

The delivering part 50 comprises a robot hand 59a on which a substrate is mounted, a robot arm 59b that moves the robot hand 59a forwards and backwards in a horizontal direction, and a carriage plate 56 that is connected between the pair of frame parts 40a and 40b. The carriage plate 56 supports the robot hand 59a and the robot arm 59b. Opposite ends of the delivering part 50 are integrally connected to the moving frames 44. In other words, opposite ends of the carriage plate 56 of the delivering part 50 are integrally connected to the moving frames 44, thereby allowing the delivering part 50 to be vertically displaced according to the elevation of the moving frame 44.

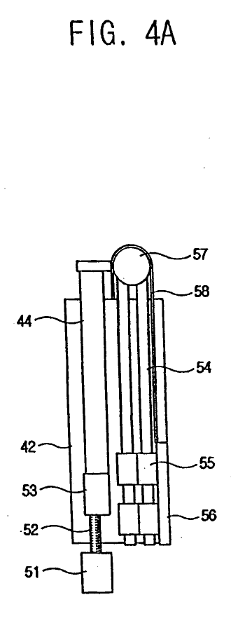

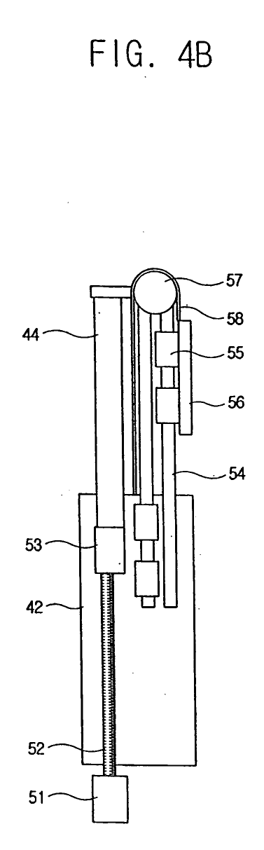

FIGS. 4A and 4B are views illustrating an operational state of a frame part of a substrate delivering apparatus according to another embodiment of the present general inventive concept. The frame part employed in this embodiment uses a screw shaft and a guide shaft, and operates as follows.

As illustrated in FIGS. 1 to 4B, a driving motor 51 that is installed on a bottom of the fixed frame 42 rotates a screw shaft 52, and a screw shaft nut 53 that is connected to the screw shaft 52 is vertically moved. As a result, a moving frame 44 is elevated according to the vertical movement of the screw shaft nut 53. An amount and speed of the elevation of the moving frame 44 are determined by a rotation speed of the screw shaft 52.

A guide shaft 54 may be provided on the fixed frame 42 to support a load in a horizontal direction when the moving frame 44 is elevated and to lead a vertical movement. The guide shaft 54 performs a vertical movement by passing through a guide shaft bush 55 fixed on the fixed frame 42.

A pulley 57 that is associated with a belt 58 is installed on top of the moving frame 44. The pulley 57 and the belt 58 cause relative elevation of the moving frame 44 and carriage plate 56. One end of the belt 58 is fixed on top of the fixed frame 42 and the other end is fixed on top of the carriage plate 56.

Therefore, as the pulley 57 is elevated according to the elevation of the moving frame 44, the belt 58 is moved in a counterclockwise direction as shown in FIG. 4B, thereby causing the elevation of the carriage plate 56. The elevation of the carriage plate 56 is led by the guide shaft 54 and the guide shaft bush 55, like the elevation of the moving frame 44. The carriage plate 56 is elevated two times as high and two times as fast as the moving frame 44.

The moving part 30, the delivering part 50, and the pair of frame parts 40a and 40b of the substrate delivering apparatus are simultaneously movable. For example, the moving part 30 may cause linear (and/or rotational) movement along a base part 20 during a time in which the moving frame 44 is being elevated. At the same time, the robot arm 59b may move the robot hand 59a forwards or backwards. In some embodiments of the present general inventive concept, the screw shaft 52 may cause the pulley 57 and the belt 58 arrangement to elevate the carriage plate 56. These simultaneous movements allow the substrate delivering apparatus to deliver large and small substrates precisely and efficiently. Movement of the substrate delivering apparatus may be automatically controlled by a controller, and the controller may control the movement of the substrate delivering apparatus without human intervention.

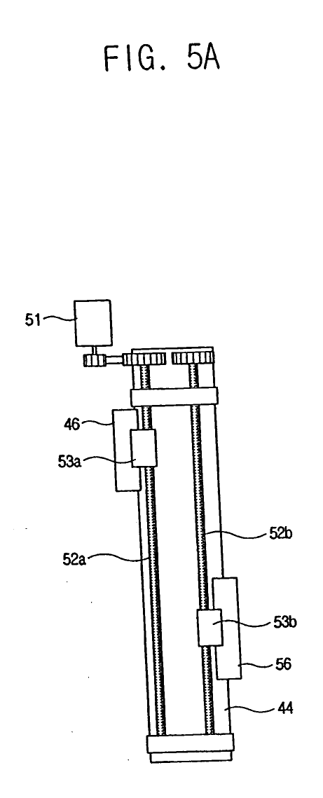

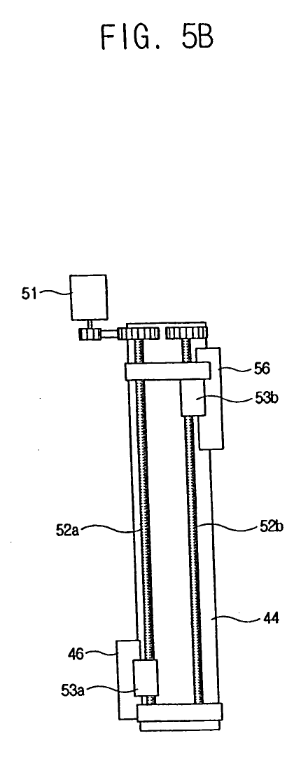

FIGS. 5A and 5B are views illustrating an operational state of a frame part of a substrate delivering apparatus according to another embodiment of the present general inventive concept. The frame part employed in this embodiment uses two screw shafts and operates as follows.

As illustrated above, a first screw shaft 52a and a second screw shaft 52b are supported by a moving frame 44 so that both ends of the first and the second screw shafts 52a and 52b can be rotated in a shaft direction. The first screw shaft 52a and the second screw shaft 52b are rotated in opposite directions when a driving motor 51 is rotated. When the first screw shaft 52a is rotated counterclockwise, a first carriage plate 46 is elevated relative to the fixed frame 42 that is connected with a first screw shaft nut 53a. An amount and speed of the elevation of the first carriage plate 46 are determined by the rotation speed of the first screw shaft 52a.

The second screw shaft 52b is rotated clockwise at the same time with the elevation of the first carriage plate 46, and a second carriage plate 56 that is connected to the second screw shaft 52b by a second screw shaft nut 53b is elevated relative to the second screw shaft 52b. Since the second carriage plate 56 is elevated relative to the moving frame 44, a gear ratio of the first screw shaft 52a and the second screw shaft 52b may be 1:1. If the first and second screw shaft 52a and 52b have the same lead, the first and second screw shaft 52a and 52b would move two times as far and two times as fast as the moving frame 44.

Accordingly, if the first carriage plate 46 is initially displaced at a topmost position relative to the fixed frame 42 and the second carriage plate 56 is displaced at a lowermost position of the second screw shaft 52b, the second carriage plate 56 would have a movement range that is equivalent to two times a height of the moving frame 44.

As described above, according to the present general inventive concept, delivering a substrate can be performed in an easy and accurate manner while securing structural stability. Large substrates may also be delivered efficiently and precisely according to the present general inventive concept.

Although the present general inventive concept has been described in connection with the exemplary embodiments illustrated in the accompanying drawings, it should be understood that the present general inventive concept is not limited thereto and those skilled in the art can make various modifications and changes without departing from the scope of the general inventive concept.

What is claimed is:

1. A substrate delivering apparatus that delivers a substrate, comprising:
a base part;
a moving part mounted on the base part so as to perform a linear movement and having a rotating body;
a pair of frame parts mounted in parallel on opposite sides of the moving part and having heights that are adjustable; and
a delivering part that is connected between the pair of frame parts and is vertically displaced according to an adjustment of the heights of the frame parts.

2. The apparatus according to claim 1, wherein the rotating body comprises a rotating part being rotatable, and a support plate part mounted on the rotating body such that the supporting plate part supports the pair of frame parts.

3. The apparatus according to claim 2, wherein the frame parts each comprise a fixed frame mounted on top of the support plate part and a moving frame coupled with the fixed frame so as to be elevatable, and the moving frame is connected to the delivering part.

4. The apparatus according to claim 3, wherein both ends of the delivering part are integrally connected to the pair of frame parts at the moving frames.

5. The apparatus according to claim 1, wherein the delivering part, the moving part, and the pair of frame parts are simultaneously movable.

6. The apparatus according to claim 1, wherein the delivering part comprises a robot hand on which a substrate is mounted and a robot arm to move the robot hand forwards and backwards with respect to one of the moving part and the pair of frame parts.

7. The apparatus according to claim 6, wherein the delivering part further comprises a carriage plate integrally connected to the pair of frame parts to support the robot hand.

8. The apparatus according to claim 1, further comprising:
a controller to control a movement of the moving part, the pair of frame parts, and the delivering part automatically and without human intervention.

9. A substrate delivering apparatus, comprising:
a moving part to provide linear and rotational movement with respect to a base part;
at least one frame part having a fixed frame mounted on the moving part and a moving frame movably coupled to the fixed frame and having an adjustable height with respect to the fixed frame in a first direction; and
a delivering part coupled to the moving frame to deliver a substrate in a second direction having a predetermined angle with the first direction.

10. The apparatus according to claim 9, further comprising:
at least one screw shaft and a driving motor attached to the fixed frame to rotate the at least one screw shaft so that a rotation of the screw shaft causes elevation of the moving frame.

11. The apparatus according to claim 10, wherein the at least one screw shaft comprises a first and a second screw shafts rotated by the driving motor in opposite directions, and first and second plates to move in upward and downward directions according to rotations of the first and second screw shafts, respectively.

12. The apparatus according to claim 11, wherein the first screw shaft and the second screw shaft have a gear ratio that is one to one.

13. The apparatus according to claim 11, wherein the delivering part has a movement range that is equal to two times a height of the moving frame.

14. The apparatus according to claim 9, wherein the at least one frame part further comprises a guide shaft to support a load in the second direction during elevation of the moving frame.

15. The apparatus according to claim 9, wherein the at least one frame part further comprises a carriage plate, a pulley disposed on a top part of the moving frame, and a belt associated with the pulley with one end fixed to the fixed frame and another end fixed to the carriage plate attached to the moving frame, wherein the pulley and the belt cause elevation of the moving frame and the carriage plate.

16. The apparatus according to claim 15, wherein as the moving frame is elevated, the pulley is elevated and the belt is rotated to control the carriage plated to be elevated.

17. The apparatus according to claim 9, wherein the second direction is disposed on a plane that is perpendicular to the first direction.

18. A substrate delivering apparatus, comprising:
at least one frame part having an adjustable height, and having a fixed frame, a moving frame, at least one screw shaft, and a driving motor that is operable to rotate the at least one screw shaft attached to the moving frame of the at least one frame part to control the adjustable height, and wherein rotation of the screw shaft causes elevation of the moving frame relative to the fixed frame of the at least one frame part; and
a substrate delivering part integrally connected to the moving frame of the at least one frame part, and having a robot hand on which a substrate is mounted and a robot arm to move the robot hand in a horizontal direction wherein the substrate delivering part is vertically displaced according to the adjustable height of the at least one frame part.

19. The apparatus according to claim 18, wherein the at least one frame part comprises two frame parts disposed in parallel with each other, and having the fixed frame and the moving frame that is elevatable with respect to the fixed frame.

20. The apparatus according to claim 19, wherein the at least one frame part further comprises a pulley disposed on a top part of the moving frame and a belt associated with the pulley with one end fixed to the fixed frame and another end fixed to the substrate delivering part, wherein the pulley and the belt cause elevation of the substrate delivering part when the adjustable height of the moving frame is adjusted with respect to the fixed frame so that a height of the substrate delivering part is increased.
